(19) United States
(12) Patent Application Publication
(10) Pub. No.: US 2016/0167763 A1
(43) Pub. Date: Jun. 16, 2016

(54) SANDWICH PANEL AND METHOD TO FORM THE PANEL

(71) Applicant: Airbus Operations Limited, Bristol (GB)

(72) Inventor: David BRAKES, Bristol (GB)

(21) Appl. No.: 14/969,946

(22) Filed: Dec. 15, 2015

(30) Foreign Application Priority Data
Dec. 15, 2014 (GB) 1422299.6

(51) Int. Cl. B64C 3/20; B32B 3/20; B32B 37/14; B32B 3/02; B32B 5/20; B64C 1/00; B32B 3/18; B32B 5/18

(52) U.S. Cl. CPC B64C 3/20; B32B 3/18; B32B 3/20; B32B 5/18; B32B 3/02; B32B 5/20; B64C 1/00; B32B 37/142; B64C 2001/0072; B32B 2605/18; B32B 2266/0271

(57) ABSTRACT

A composite panel including first and second parallel planar face sheets and a core sandwiched between the first and second face sheets. The core includes a regular array of solid elements bonded to the first and second face sheets. Also, a method of manufacturing the composite panel.

### RELATED APPLICATION

This application claims priority to United Kingdom patent application 1422299.6 filed Dec. 15, 2014, the entirety of which is incorporated by reference.

### TECHNICAL FIELD

The present invention relates to sandwich panels and, in particular, to sandwich panels for use in aircraft structures.

### BACKGROUND

Sandwich panels are known which comprise spaced face sheets bonded to a foam core. Such panels can achieve a high out-of-plane bending stiffness with a low weight by sandwiching a low-density core material with high stiffness face sheets. For example, a foam core bonded to carbon fibre reinforced plastic face sheets. Such panels are advantageous in a wide variety of applications where light stiff panels are required, such as construction, automotive and aerospace industries. Examples within the aerospace industry include floor panels, access panels, fairings, control surfaces and cover panels (skins) for wings or empennage (vertical and horizontal tail stabilising fins).

Exterior panels in aircraft in particular are exposed to potential foreign object impact damage. To prevent failure of panels from such damage, aircraft panels may be made thicker and heavier to withstand foreign object impact. However, in aerospace applications, weight is a critical factor for efficient performance and so excessively heavy panels are undesirable.

It is therefore an object of the invention to provide a sandwich panel that substantially overcomes or alleviates problems with known sandwich panels mentioned above.

### SUMMARY

According to the present invention there is provided a composite panel comprising first and second parallel planar face sheets and, a core sandwiched between the first and second face sheets, wherein the core comprises a regular array of solid elements bonded to the first and second face sheets.

Each solid element may be in contact with and bonded to the adjacent solid elements. The solid elements may be arranged in regular rows and columns. The core may comprise a single layer of solid elements each bonded to both the first and second face sheets.

Each solid element may comprise a spherical ball. The solid elements may be hollow.

Voids between the solid elements may be filled with a filler material. The filler material may comprise a structural foam. The foam may be a foam set hard from a liquid state. The filler material may be a liquid material that expands or is non-expanding as it sets hard. Alternatively, the filler material may be formed from a solid slab and machined to shape.

The first and second face sheets may be bonded together along an edge of the panel to form a solid flange at the panel edge. The first and second face sheets may taper together to the solid flange along the panel edge. The core may comprise solid elements of a reduced size provided between the first and second face sheets in the tapering panel edge section. The solid elements in the tapering panel edge section may be bonded to the first and second face sheets. The solid elements in the tapering panel edge section may be bonded to adjacent solid elements. Voids between the first and second face sheets in the tapering panel edge section may be filled with a filler material.

The solid elements may be made of plastic or fibre reinforced plastic.

The composite panel may further comprise an insert fixedly secured within a solid element, extending through at least one of the first and second face sheets and projecting from the surface of the composite panel.

The insert may be secured within a cavity within the solid element by a set potting compound within the cavity.

The present invention also provides a component of an aircraft comprising a composite panel as described above. The component may comprise one of a wing, empennage, fuselage, fairing or movable aerodynamic device such as a flap, aileron or spoiler.

The present invention also provides an aircraft comprising a component as described above.

The present invention also provides a method of manufacturing a composite panel comprising providing first and second parallel planar face sheets and sandwiching a core of a regular array of solid elements between the first and second face sheets.

The method may comprise bonding each solid element to the adjacent solid elements.

The method may comprise arranging the solid elements of the core as a single layer of solid elements between the first and second face sheets. The method may comprise filling voids between the solid elements with a filler material. The filler material may be injected as a liquid and sets hard in the voids between the solid elements.

Alternatively, the method may comprise providing a first solid layer of filler material with recesses to receive the solid elements, and providing the solid elements within the recesses of the first solid layer. The method may comprise providing a second solid layer of filler material with recesses to receive the solid elements, and disposing the second solid layer over the solid elements in the first solid layer. The first and second solid layers may be bonded both to each other and to the array of solid elements between the first and second solid layers.

The method may comprise forming the first and second solid layers as an integral body and folding the second solid layer over the first solid layer in a clam-shell configuration to enclose the solid elements.

The method may comprise first forming the core as a solid slab of the solid elements and solid filler material between the solid elements, and subsequently applying the first and second face sheets to the solid slab core. The method may comprise machining flat first and second surfaces of the solid slab core before applying the first and second face sheets to the solid slab core.

The method may comprise providing a plurality of the solid elements as a sheet by adhering a plurality of solid elements together into a regular array before sandwiching the solid elements between the first and second face sheets, and draping the adhered array of solid elements as a sheet into position to form the core of the composite panel.

The method may comprise bonding the first and second face sheets together along an edge of the panel to form a solid flange at the panel edge. The method may comprise forming the panel edge such that the first and second face sheets taper together to the solid flange along the panel edge. The method may comprise providing solid elements of a reduced size between the first and second face sheets in the tapering panel edge section. The method may comprise bonding the solid elements in the tapering panel edge section to the first and second face sheets. The method may comprise bonding the solid elements in the tapering panel edge section to adjacent solid elements. The method may comprise filling voids between the first and second face sheets in the tapering panel edge section with a filler material.

The method may comprise fixedly securing an insert within a solid element, extending through at least one of the first and second face sheets and projecting from the surface of the composite panel.

The method may comprise securing the insert within a cavity within the solid element by introducing a potting compound within the cavity and setting the potting compound.

### BRIEF DESCRIPTION OF THE DRAWINGS

Embodiments of the invention will now be described, by way of example only, with reference to the accompanying drawings, in which:

FIG. 1 shows a plan view from above of an aircraft including a sandwich panel according to a first embodiment of the invention;

FIG. 2 shows a plan view of a wing of the aircraft of FIG. 1;

FIG. 3 shows a perspective view of a portion of a sandwich panel of a first embodiment of the invention with the foam core omitted and upper face sheet shown as transparent for ease of illustration;

FIG. 4 shows a cross-sectional view through the portion of sandwich panel shown in FIG. 3 along the line X-X, showing shear loads;

FIG. 5 shows a cross-sectional view through the portion of sandwich panel shown in FIG. 3, showing an impact point between face-sheet bonds on core balls;

FIG. 6 shows a perspective view of the portion of sandwich panel shown in FIG. 3 showing delamination and containment zones after an impact as shown in FIG. 5;

FIG. 7 shows a cross-sectional view through the portion of sandwich panel shown in FIG. 3, showing an impact point at a face-sheet bonds on a core ball;

FIG. 8 shows a perspective view of the portion of sandwich panel shown in FIG. 3 showing delamination and containment zones after an impact as shown in FIG. 7;

FIG. 9 shows a first variant of an edge configuration of the sandwich panel shown in FIG. 3;

FIG. 10 shows a second variant of an edge configuration of the sandwich panel shown in FIG. 3;

FIG. 11 shows a third variant of an edge configuration of the sandwich panel shown in FIG. 3;

FIG. 12 shows a fourth variant of an edge configuration of the sandwich panel shown in FIG. 3;

FIG. 13 shows a perspective view of a portion of a sandwich panel of a second embodiment of the invention with the foam core omitted and upper face sheet shown as transparent for ease of illustration, and showing ball loads;

FIG. 14 shows a cross-sectional view through the portion of sandwich panel shown in FIG. 12 along the line Y-Y; and

FIG. 15 shows a perspective view of a portion of a sandwich panel of a third embodiment of the invention with the foam core omitted and upper face sheet shown as transparent for ease of illustration.

### DETAILED DESCRIPTION

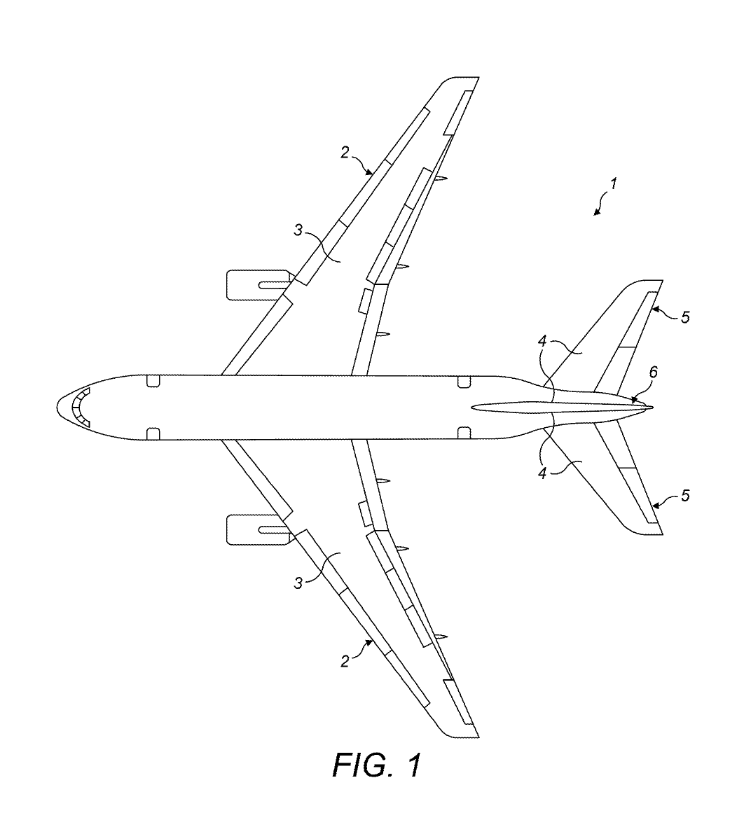

FIG. 1 shows a plan view of an aircraft 1 including a number of surfaces comprising sandwich panels 10 of the invention, and includes the upper and lower covers or “skins” 3 of the wings 2 (only the upper skins 3 are shown in FIG. 1) and the skins 4 of the empennage comprising the horizontal and vertical tail fins 5, 6.

FIG. 2 shows a plan view of a wing 2 of the aircraft 1 shown in FIG. 1, including the upper skin 3.

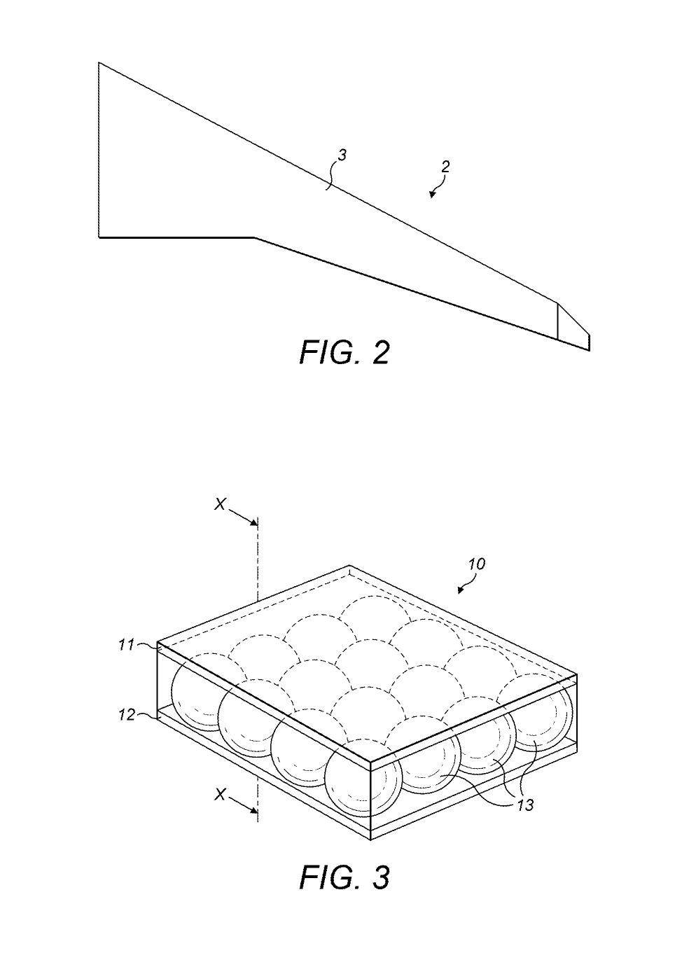

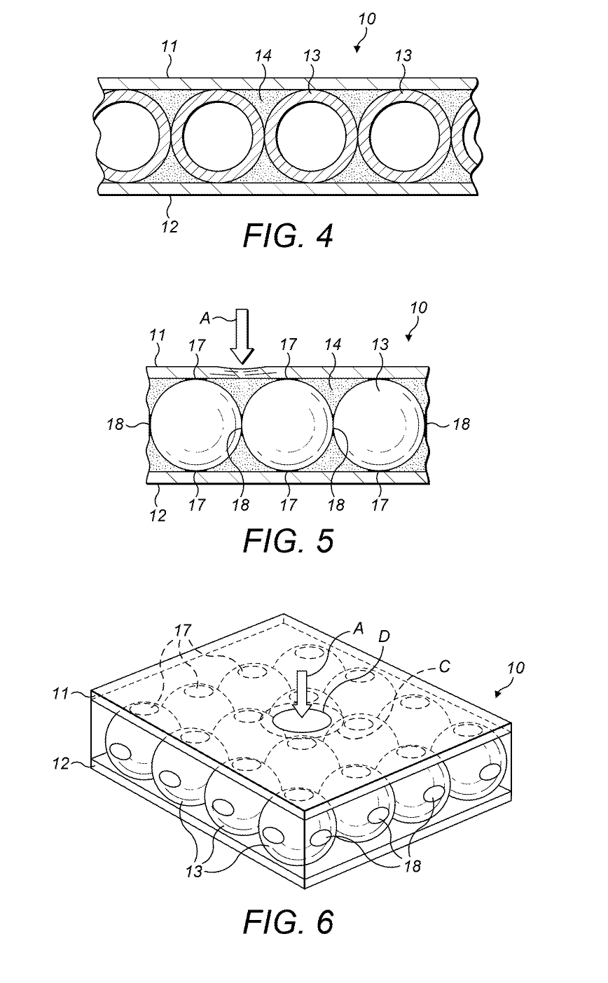

FIGS. 3 and 4 show views of a portion of a sandwich panel 10 of a first embodiment of the invention which comprises first and second face sheets 11, 12 sandwiching a core comprising an array of balls 13 with a structural foam 14 filling the voids between the balls 13. (The first and second face sheets 11, 12 will hereafter be described as upper and lower face sheets 11, 12 respectively, due to the orientation shown in the figures, although the invention is not limited to any particular orientation of the panels). The balls 13 are arranged in a regular array of rows and columns and each ball 13 is in contact with and bonded to its adjacent neighbours. Each ball 13 is also in contact with and bonded to the upper and lower face sheets 11, 12.

The balls 13 are hollow, as shown in FIG. 4, and may be made from plastic or fibre reinforced plastic. The fibre reinforcement in such balls 13 may be either continuous fibre or chopped fibre set in resin. The balls 13 being hollow provides the advantage of minimising the weight of the panel 10 which is important in such applications as the aerospace industry where weight is a critical component design factor.

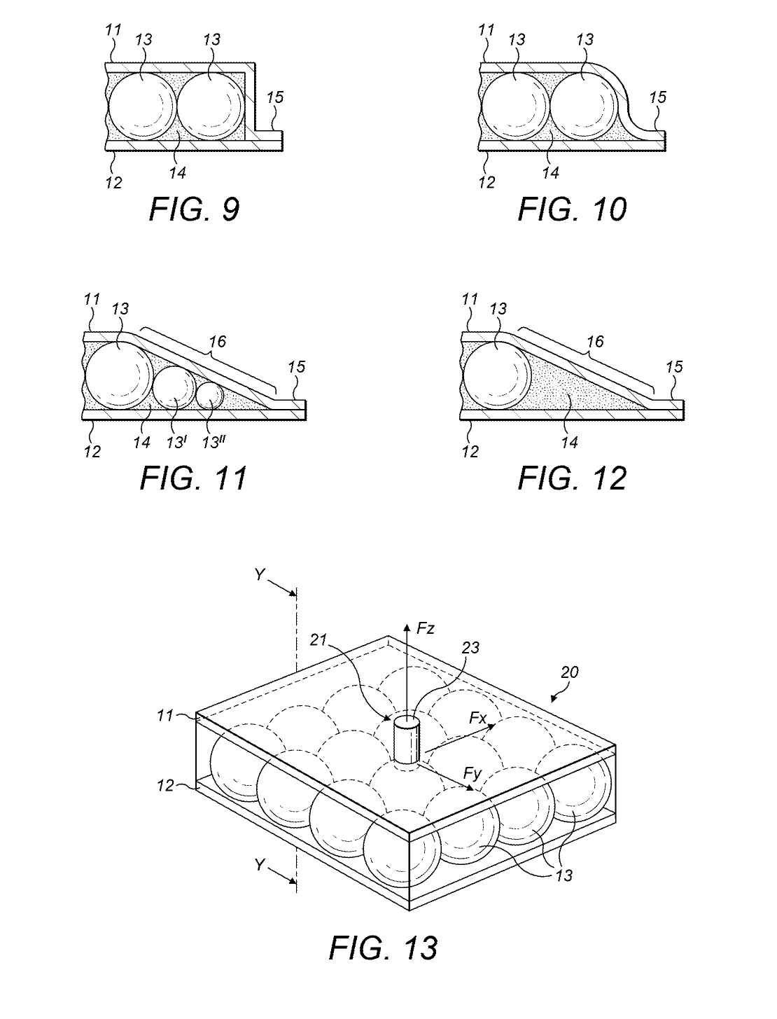

At the panel edges, the upper and lower face sheets 11, 12 come together and are bonded directly to one another to form a solid monolithic flange 15 through which the panel 10 may be riveted or otherwise mechanically secured in place on the aircraft structure such as the spars, ribs, skeleton or frame of the wing or fuselage. FIGS. 9-12 show four variations of panel edge configuration. In the first variant shown in FIG. 9, the upper face sheet 11 is simply squared off around the ball 13 at the panel edge at 90 degrees. In the second variant shown in FIG. 10, the upper face sheet 11 is curved around the outer upper quarter of the ball 13 at the panel edge and curves back to meet the lower face sheet 12 at the solid flange 15. In the third variant shown in FIG. 11, the upper face sheet 11 tapers gradually towards the lower face sheet 12 before coming into contact with the lower face sheet 12 to form the solid flange 15. In order to support the sandwich panel 10 over this tapering edge section 16, the core includes balls 13′, 13″ of reduced diameter within the tapering edge section 16. The smaller balls 13′, 13″ are still each in contact with, and bonded to, the upper and lower face sheets 11, 12, and are also in contact with and bonded to adjacent balls 13, 13′, 13″, even if not of the same size. The fourth variant shown in FIG. 12 is similar to the third variant, except that there are no balls 13′, 13″ of reduced diameter in the region of the tapering edge section 16 and instead, the core comprises only the structural foam 14 in this region.

An advantage of the ball-core sandwich panel 10 of the invention is that its configuration discretises the shear path through the core material such that impact damage to the panel 10 remains localised. In conventional sandwich panels, the face sheets are bonded to a uniform homogenous core material and so the shear flow of force on the face sheets is carried continuously through the core. However, in the ball-core configuration of the invention, the balls 13 form the primary shear path between the face sheets 11, 12 producing a form of vaulted structure and the structural foam 14 between the balls 13 inhibits local buckling of the face sheets 11, 12. As such, discrete shear loads are carried between the balls 13 at the ball-to-ball bonds and, as the structural foam 14 is less stiff than the balls 13, complementary shear loads will predominantly be carried across the ball-to-face sheet bonds. This discretisation of the shear path produces regions of very low shear flow (i.e. where the face sheets 11, 12 are bonded to the structural foam 14). In the event of a foreign object impact on the panel 10, these low-load regions act to slow or stop the propagation of delamination of the face sheet 11, 12 from the core.

The discretisation of the shear load path creates containment zones where the shear flow between the face sheets 11, 12 and the structural foam 14 is very low. These containment zones are bounded by the adjacent ball-to-face sheet bonds. Therefore, any delaminating due to an impact on the panel 10 will advantageously be confined to within the containment zones, effectively containing the damage and thereby making the panel 10 much more damage tolerant than conventional sandwich panels.

FIGS. 5 and 6 illustrate the above-described effect of containing impact damage, in a situation where an object impacts the panel between the ball-to-face sheet bonds, as shown by arrow A. The ball-to-face sheet bonds are shown as circled areas with reference numeral 17 and the ball-to-ball bonds are shown as circled areas with reference numeral 18. In this situation, an area around the impact point where the face sheet 11 is bonded to the structural foam 14 of the core will delaminate, shown as a delamination zone D within the solid circled area. However, the delamination of the face sheet 11 from the core will be contained within a delamination containment zone C within the dashed circled area, which is bounded and defined by the ball-to-face sheet bonds 17. Thereby, the damage caused by the impact is effectively contained and so the panel 10 is significantly more damage-tolerant than conventional sandwich panels.

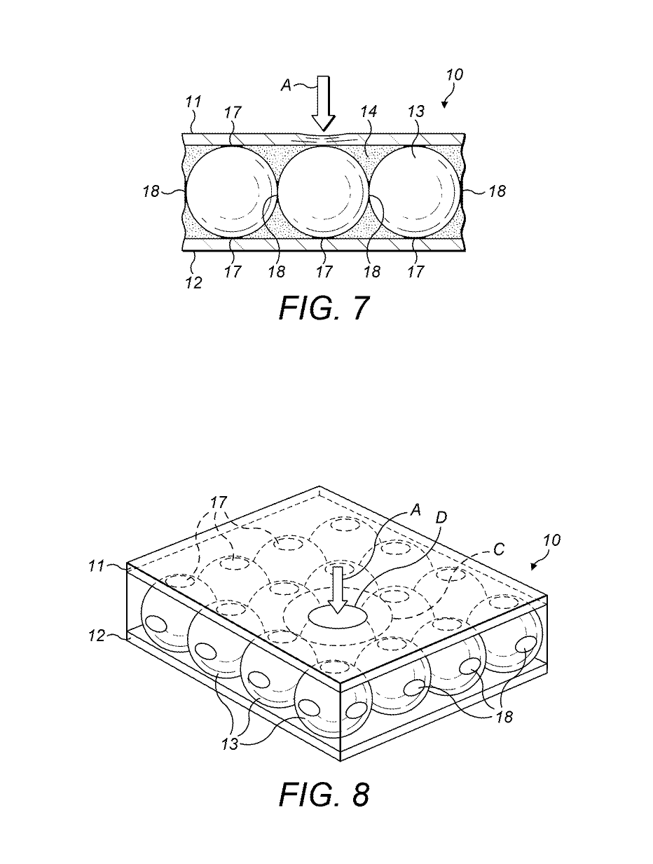

FIGS. 7 and 8 illustrate a situation where an object impacts the panel at a ball-to-face sheet bond 17, as shown by arrow B. In this situation, the bond between the ball 13 and the face sheet 11 at the point of impact may be damaged and fail, and the surrounding area where the face sheet 11 is bonded to the structural foam 14 may delaminate, over a delamination zone D shown within the solid circle. However, as with the previous situation shown in FIGS. 5 and 6, the delamination of the face sheet 11 from the core will be contained within a delamination containment zone C shown within the dashed circled area, which is bounded and defined by the surrounding ball-to-face sheet bonds. Again, the damage caused by the impact is effectively contained, rendering the panel 10 significantly more damage-tolerant than conventional sandwich panels.

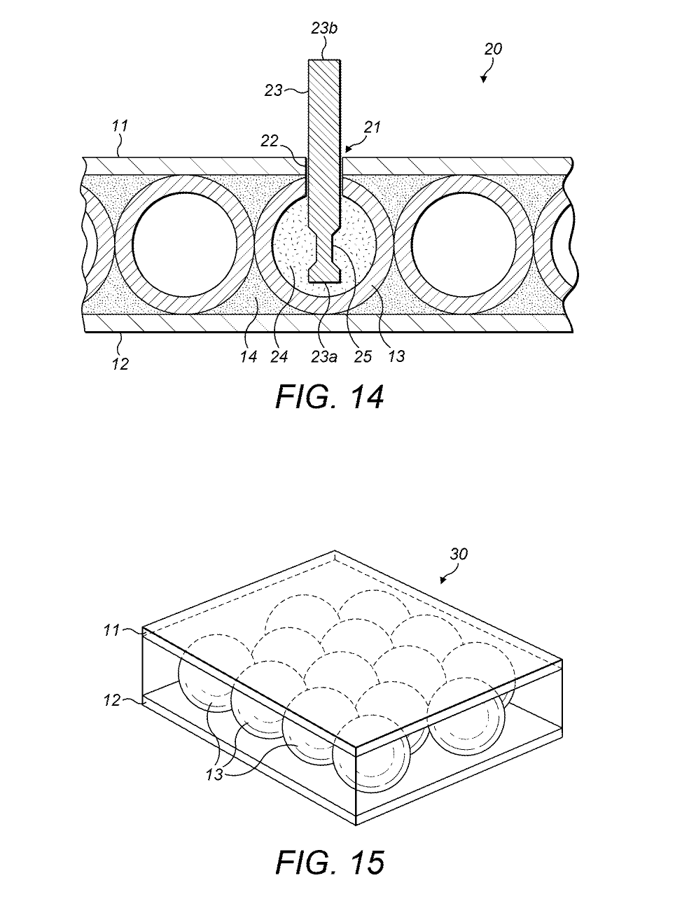

FIGS. 13 and 14 show a sandwich panel 20 of a second embodiment of the invention. A number of features of the second embodiment are similar to those of the first embodiment shown in FIGS. 3-12 and retain the same reference numerals, and so a detailed description of these similar features will not be repeated.

A difference of the sandwich panel 20 of the second embodiment over the first embodiment is that the panel 20 includes an attachment point 21 cast into the panel 20. The attachment point 21 comprises a hole 22 drilled though one of the face sheets 11, 12 (the upper face sheet 11 in the embodiment illustrated) and into one of the hollow balls 13 within the core of the panel 20. An insert 23 is positioned though the hole 22 with one end 23a within the hollow interior of the ball 13 and the opposite end 23b projecting beyond the plane of the face sheet 11. The void of the hollow ball 13 is then filled with a potting/fixing compound 24 which sets and fixes the insert 23 in place. The insert 23 includes a narrowed waist 25 at a portion disposed within the ball 13 which acts to anchor the insert 23 in place and prevent it from being pulled out of the panel 20.

Once fixed in place, the projecting end 23b of the insert 23 can be used as a mounting point for other structural components, such as a fairing. The projecting end 23b of the insert 23 may include a thread, annular recess or other formation to enable mechanical fastening. The loads exerted upon the insert 23 in use by a component connected to the insert 23 are shown in FIG. 13. Loads out of the plane of the panel 20, shown by arrow F_{z}, are transferred as a shear load into the adjacent balls 13 at the ball-to-ball bonds. Loads in the plane of the panel 20, shown by arrows Fₓ, F_{y}, are transferred into adjacent balls at the ball-to-ball bonds, and from there they are then transferred as shear loads to the face sheets 11, 12 at the ball-to-face sheet bonds.

In the panels 10, 20 of the first and second embodiments, the array of balls 13 of the panel core are arranged in alignment in regular rows and columns. However, the invention is not limited to this configuration and FIG. 15 shows a perspective view of a portion of a sandwich panel 30 of a third embodiment of the invention having an alternative configuration within the scope of the invention. The balls 13 of the panel of the third embodiment are arranged in straight columns but with adjacent columns being off-set so that the balls 13 do not lie in regular rows. The balls 13 are still bonded to their adjacent neighbouring balls 13, and are also each bonded to the upper and lower face sheets 11, 12, and serve to transfer loads of impact of other forces exerted on the panel 30 in the same manner as described above. Therefore, the panel 30 of the third embodiment also has the advantageous impact-resistant and damage-tolerant properties of the panels 10, 20 of the first and second embodiments described above.

Various methods of manufacture of the above-described sandwich panels are included within the scope of the invention, as described hereafter. A first method of manufacture is to first bond the array of balls 13 to the lower face sheet 12. Subsequently, the filler material 14 is injected in liquid form in the voids around the balls 13 and the upper face sheet 11 is then placed on top of the array of balls 13 and filler material 14 by an external tool, sandwiching the balls 13 and filler material 14 between the upper and lower face sheets 11, 12, and squeezing out any excess filler material. At this time, the upper face sheet 11 is bonded to the balls 13. The filler material 14 would then set hard as the whole panel is cured. In such a method, the filler material 14 would comprise a non-expanding material and may comprise an epoxy material, such as Syncore™. Also, the epoxy in the filler material 14 would be compatible with the epoxy in the face sheets 11, 12 and that at the ball-to-ball and ball-to-face sheet bonds.

A second method of manufacture within the scope of the invention is similar to the first method described above, and comprises injecting liquid filler material in the voids between balls 13. However, a difference with the second method of manufacture is that the filler material 14 is allowed to set hard before the upper face sheet 11 is bonded onto the core. In this case, an additional manufacturing step would be required after the filler 14 has set hard, comprising machining flat the top surface of the core which would ensure a flat surface for the upper face sheet 11 to bond to, and would ensure all of the tops of the balls 13 are exposed to be bonded to the upper face sheet 11.

A third method of manufacture of the sandwich panels may comprise first sandwiching the array of balls 13 between the upper and lower face sheets 11, 12 and bonding the balls 13 to the face sheets 11, 12. Subsequently, the filler material 14 may be injected in liquid form between the face sheets 11, 12 to fill the voids between the balls 13 and would then set hard. The filler material 14 may be a non-expanding material such as that described above, or may be an expanding material such as a structural foam, such as “foam-in-place” type foam, which would expand once injected into the core between the face sheets 11, 12 to fill all voids between the balls 13. In the case of use of expanding foam filler 14, external tooling may be used to support the upper and lower face sheets 11, 12 to prevent them from bulging under the foam expansion pressure. The face sheets 11, 12 may be pre-cured or may cure after the foam/filler material 14 has expanded and/or set.

A fourth method of manufacture of sandwich panels of the invention comprises providing the filler material 14 as a solid material prior to providing the balls 13 to form the core of the sandwich panel. In such a method, a first solid layer of filler material 14 may be provided, with a plurality of recesses in one face to receive the balls 13. A second solid layer of filler material 14, similarly with a plurality of recesses in one face to accommodate the balls 13, may then be provided and placed over the top of the first sheet and the balls 13 thereon, to form the solid core of the sandwich panel. In forming the solid core of the sandwich panel in this way, the first and second solid layers would be bonded both to each other and to the balls 13. The upper and lower face sheets 11, 12 could then be bonded to the outer faces of the solid layers of filler material to form the completed sandwich panel. In such an embodiment, the first and second solid layers could be provided as separate pre-formed components. Alternatively, the first and second solid layers could be formed integrally and hingeable relative to each other, for example along a live hinge between the first and second solid layers. Once the array of balls 13 is placed in the recesses of the first solid layer, the second solid layer could be pivoted into position onto the first solid layer about the hinge or other join, in a clam-shell type arrangement.

A fifth method of manufacture of sandwich panels of the invention comprises providing the ball-core of the sandwich panel, made of the balls 13 and surrounding filler material 14, as a pre-formed “slab-stock” prior to applying the upper and lower face sheets 11, 12 to the core. Here, any of the methods mentioned above could be used to make the core, such as by injecting non-expanding or expandable filler material 14 between a pre-arranged array of balls 13, or by forming the filler material 14 as solid layers before placing the array of balls 13 one on layer and bonding the second solid layer in place. However, external tooling would be required to take the place of the upper and/or lower face sheets 11, 12, especially in the methods using a solidifying liquid filler material 14, so that the array of balls 13 are placed on the tooling and the filler material 14 injected and solidified to form the solid slab-stock core. The core would then be removed from the tooling and the upper and lower face sheets 11, 12 bonded to the solid slab-stock core. In such a fifth method of manufacture, the solidified slab-stock core may be machined to create flat upper and lower faces upon which the upper and lower face sheets 11, 12 can be laid and cured. As with the second method described above, this could ensure all of the tops of the balls 13 are exposed to be bonded to the upper and lower face sheets 11, 12.

In any of the methods of manufacture described above, the array of balls 13 may be provided in a pre-formed sheet with adjacent balls 13 already bonded to each other. In such an arrangement, the balls 13 may be tacked together using un-cured or part-cured adhesive to form a sheet that can be draped into position.

Although the composite sandwich panels 10, 20, 30 of the first to third embodiments of the invention described above comprise hollow balls 13, the invention is not limited to such a configuration and alternatively, solid balls may be used. Alternatively, balls with a central cavity filled with an alternative material, such as foam, liquid, or other compound, is intended to be included within the scope of the invention.

Although the composite sandwich panels 10, 20, 30 of the first to third embodiments of the invention described above comprise balls 13 within the core, the invention is not intended to be limited to spherical balls being used, and other shaped solid elements may be provided as the array of discrete solid elements between and bonded to the first and second face sheets 11, 12. That is, “solid” elements in the context of being substantially hard or firm, although as described above, such solid elements may have a hollow core or may be homogenous throughout their cross-section. Example solid elements within the scope of the invention may be ovoid elements or polyhedral elements. Such alternative shaped elements, such as polyhedral elements, may provide the advantage of having larger surface area (e.g. of the faces of the polyhedrons) to bond the elements to each other and to the upper and lower face sheets. However, spherical ball elements are preferable due to their infinite symmetry as they do not require particular orientation within the core of the sandwich panel.

Use of the term “solid” herein when referring to the filler material 14 is intended to be construed in the context of material state, that is the material is not liquid, and does not necessarily mean the material is of uniform homogenous nature. For example, the filler material 14 may be a “solid” or “solidified” foam which, although a stiff material, may include many air pockets within the structure of the material.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A composite panel comprising first and second parallel planar face sheets and, a core sandwiched between the first and second face sheets, wherein the core comprises a regular array of solid elements bonded to the first and second face sheets.

2. The composite panel according to claim 1 wherein each solid element is in contact with and is bonded to the adjacent solid elements.

3. The composite panel according to claim 1 wherein the solid elements are arranged in regular rows and columns.

4. The composite panel according to claim 1 wherein the core comprises a single layer of solid elements each bonded to both the first and second face sheets.

5. The composite panel according to claim 1 wherein each solid element comprises a spherical ball.

6. The composite panel according to claim 1 wherein the solid elements are hollow

7. The composite panel according to claim 1 wherein voids between the solid elements are filled with a filler material.

8. The composite panel according to claim 7 wherein the filler material comprises a structural foam.

9. The composite panel according to claim 1 wherein the first and second face sheets are bonded together along an edge of the panel to form a solid flange at the panel edge.

10. The composite panel according to claim 9 wherein the first and second face sheets taper together to the solid flange along the panel edge.

11. The composite panel according to claim 10 wherein the core comprises solid elements of a reduced size provided between the first and second face sheets in the tapering panel edge section.

12. The composite panel according to claim 11 wherein the solid elements in the tapering panel edge section are bonded to the first and second face sheets.

13. The composite panel according to claim 11 wherein the solid elements in the tapering panel edge section are bonded to adjacent solid elements.

14. The composite panel according to claim 10 wherein voids between the first and second face sheets in the tapering panel edge section are filled with a filler material.

15. The composite panel according claim 1 wherein the solid elements are made of plastic or fibre reinforced plastic.

16. The composite panel according to claim 1 further comprising an insert fixedly secured within a solid element, extending through at least one of the first and second face sheets and projecting from the surface of the composite panel.

17. The composite panel according to claim 16 wherein the insert is secured within a cavity within the solid element by a set potting compound within the cavity.

18. The component of an aircraft comprising a composite panel according to claim 1.

19. The component of an aircraft according to claim 18 wherein the component comprises one of a wing, empennage, fuselage, fairing or movable aerodynamic device such as a flap, aileron or spoiler.

20. An aircraft comprising a component according to claim 18.

21. A method of manufacturing a composite panel comprising providing first and second parallel planar face sheets and sandwiching a core of a regular array of solid elements between the first and second face sheets.

22. The method according to claim 21 comprising bonding each solid element to the adjacent solid elements.

23. The method according to claim 21 comprising arranging the solid elements of the core as a single layer of solid elements between the first and second face sheets.

24. The method according to claim 21 comprising filling voids between the solid elements with a filler material.

25. The method according to claim 24 wherein the filler material is injected as a liquid and sets hard in the voids between the solid elements.

26. The method according to claim 24 comprising providing a first solid layer of filler material with recesses to receive the solid elements, and providing the solid elements within the recesses of the first solid layer.

27. The method according to claim 26 comprising providing a second solid layer of filler material with recesses to receive the solid elements, and disposing the second solid layer over the solid elements in the first solid layer.

28. The method according to claim 27 comprising forming the first and second solid layers as an integral body and folding the second solid layer over the first solid layer in a clam-shell configuration to enclose the solid elements.

29. The method according to claim 23 comprising first forming the core as a solid slab of the solid elements and solid filler material between the solid elements, and subsequently applying the first and second face sheets to the solid slab core.

30. The method according to claim 29 comprising machining flat the first and second surfaces of the solid slab core before applying the first and second face sheets to the solid slab core.

31. The method according to claim 21 comprising providing a plurality of the solid elements as a sheet by adhering a plurality of solid elements together into a regular array before sandwiching the solid elements between the first and second face sheets, and draping the adhered array of solid elements as a sheet into position to form the core of the composite panel.

32. The method according to claim 21 comprising bonding the first and second face sheets together along an edge of the panel to form a solid flange at the panel edge.

33. The method according to claim 32 comprising forming the panel edge such that the first and second face sheets taper together to the solid flange along the panel edge.

34. The method according to claim 32 comprising providing solid elements of a reduced size between the first and second face sheets in the tapering panel edge section.

35. The method according to claim 34 comprising bonding the solid elements in the tapering panel edge section to the first and second face sheets.

36. The method according to claim 34 comprising bonding the solid elements in the tapering panel edge section to adjacent solid elements.

37. The method according to claim 33 comprising filling voids between the first and second face sheets in the tapering panel edge section with a filler material.

38. The method according to claim 21 comprising fixedly securing an insert within a solid element, extending through at least one of the first and second face sheets and projecting from the surface of the composite panel.

39. The method according to claim 38 comprising securing the insert within a cavity within the solid element by introducing a potting compound within the cavity and setting the potting compound.
